(19) United States
(12) Patent Application Publication
(10) Pub. No.: US 2011/0182350 A1
(43) Pub. Date: Jul. 28, 2011

(54) MOTION PICTURE CODING DEVICE AND METHOD

(76) Inventor: Tae Meon Bae, Daegu (KR)

(21) Appl. No.: 12/737,714

(22) PCT Filed: Nov. 12, 2008
(86) PCT No.: PCT/KR2008/006657

§ 371 Date: Feb. 8, 2011

(30) Foreign Application Priority Data
May 13, 2008 (KR) 10-2008-0043801

(51) Int. Cl. H04N 7/12

(52) U.S. Cl. 375/240.01; 375/E07.001

(57) ABSTRACT

The present invention relates to a motion picture encoding apparatus and method for performing encoding on a motion picture, which has already been edited, simultaneously with a motion picture edition process, thereby being capable of significantly reducing the time that it takes to encode motion pictures. The picture encoding apparatus according to the present invention includes an input unit inputting a command to edit motion picture data, a motion picture editing unit editing the motion picture data according to the editing command, a motion picture encoding unit encoding the edited motion picture data, a storage unit for storing the encoded motion picture data, and a control unit which controls the motion picture editing unit so that the motion picture editing unit edits motion picture data and, at the same time, controls the motion picture encoding unit so that the motion picture encoding unit encodes edited data.

### TECHNICAL FIELD

The present invention relates to a motion picture encoding apparatus and method, and more particularly, to a motion picture encoding apparatus and method for encoding a part of a motion picture which has already been edited simultaneously with the edition of the other part of the motion picture which has not yet been edited in a process of editing pictures, such as deleting some frames in a motion picture, adding new frames to a motion picture, or applying some image processing effects to a motion picture. According to the invention, it is possible to reduce the time to code a motion picture significantly.

### BACKGROUND ART

With the recent development of information communication technology, multimedia services capable of servicing various pieces of information, such as characters, music, and pictures, are increasing.

A user who uses this multimedia service frequently has to edit his multimedia data. The edited multimedia data is stored in a storage medium after undergoing an encoding process.

However, although a user has edited some sections of multimedia data, the entire multimedia data, including the edited sections, must be encoded at the time of encoding. Accordingly, there was a problem in that a lot of time is taken to encode multimedia data of a large capacity.

### DISCLOSURE OF INVENTION

### Technical Problem

The present invention has been made in view of the above problem occurring in the prior art, and an object of the present invention is to encode a part of a motion picture which has already been edited simultaneously with the edition of the other part of the motion picture which has not yet been edited in a process of editing pictures, such as deleting some frames in a motion picture, adding new frames to a motion picture, applying some image processing effects to a motion picture, or storing edited motion pictures. According to the invention, it is possible to reduce the time to code a motion picture significantly.

### Technical Solution

To achieve the above object, a motion picture encoding apparatus according to the present invention includes an input unit inputting a command to edit motion picture data; a motion picture editing unit editing the motion picture data according to the editing command; a motion picture encoding unit encoding the edited motion picture data; a storage unit for storing the encoded motion picture data; and a control unit which controls the motion picture editing unit so that the motion picture editing unit edits motion picture data and, at the same time, the motion picture encoding unit to encode edited data.

Here, the motion picture editing unit and the motion picture encoding unit operate at the same time in parallel.

Further, the control unit determines whether the motion picture data is encoded motion picture or not and, if the motion picture data is not encoded motion picture, performs encoding on a first frame to a last frame of the motion picture.

Further, in relation to motion picture data to be encoded, the control unit controls the motion picture encoding unit so that the motion picture encoding unit encodes data of sections other than a picture section of a portion, which is being edited by the motion picture editing unit.

Further, when the motion picture editing unit edits other picture sections of motion picture data after editing a specific picture section of the motion picture data, the control unit controls the edited picture section so that the edited picture section is encoded.

Further, in the case in which edition is not performed in a current edition section of motion picture data that is being edited by the motion picture editing unit, the control unit controls the edition section so that the edition section is encoded.

Further, in the case in which a picture section encoded by the motion picture encoding unit is edited by the motion picture editing unit, the control unit controls the edited picture section so that the edited picture section is encoded again.

In the motion picture encoding apparatus according to the present invention, in the case in which the motion picture data is Moving Picture Expert Group (MPEG)-based motion picture data, the motion picture encoding unit performs encoding on the motion picture data in a Group Of Picture (GOP) unit.

Further, when a picture section edited by the motion picture editing unit differs from a GOP unit, the motion picture editing unit binds one or more GOPs and sets the bound GOPs as an edition section, and the motion picture encoding unit performs encoding in the bound GOP section unit.

Meanwhile, in order to achieve the above object, a motion picture encoding method of the present invention includes the steps of (a) receiving a command to edit motion picture data; (b) while editing the motion picture data using a motion picture editing unit according to the editing command, encoding motion picture data on which edition has been completed using a motion picture encoding unit; and (c) storing the encoded motion picture data.

Further, the step (b) includes determining whether the motion picture data is encoded motion picture data or not, and, if the motion picture data is not encoded motion picture data, performing encoding on a first frame to a last frame of the motion picture.

Further, the step (b) includes encoding data of sections other than the picture section of the portion, which is being edited.

Further, the step (b) includes, when editing other picture sections of the motion picture data after editing a specific picture section of the motion picture data, encoding data of the specific picture section on which the edition has been completed.

Further, the step (b) includes, in the case in which edition is not performed in a current edition section of the motion picture data that is being edited, encoding the edition section in which the edition is not performed.

Further, the step (b) includes, in the case in which encoded picture section is edited, encoding the edited picture section again.

Further, the step (b) includes, when the motion picture data is MPEG-based motion picture data, encoding the motion picture data in a GOP unit.

Further, in the case in which the edited picture section differs from a GOP unit, one or more GOPs are bound, the bound GOPs is set as an edition section, and encoding is performed in the bound GOP section unit.

Meanwhile, in order to achieve the above object, a recording medium according to the present invention has a program recorded therein, the program processing the steps of (a) receiving a command to edit motion picture data; (b) while editing the motion picture data using a motion picture editing unit according to the editing command, encoding motion picture data on which edition has been completed using a motion picture encoding unit; and (c) storing the encoded motion picture data.

Further, the step (b) includes determining whether the motion picture data is encoded motion picture data or not, and, if the motion picture data is not encoded motion picture data, performing encoding on a first frame to a last frame of the motion picture.

Further, the step (b) includes encoding data of sections other than the picture section of the portion, which is being edited.

Further, the step (b) includes, when editing other picture sections of the motion picture data after editing a specific picture section of the motion picture data, encoding data of the specific picture section on which the edition has been completed.

Further, the step (b) includes, in the case in which edition is not performed in a current edition section of the motion picture data that is being edited, encoding the edition section in which the edition is not performed.

Further, the step (b) includes, in the case in which encoded picture section is edited, encoding the edited picture section again.

Further, the step (b) includes, when the motion picture data is MPEG-based motion picture data, encoding the motion picture data in a GOP unit.

Further, in the case in which the edited picture section differs from a GOP unit, one or more GOPs are bound, the bound GOPs is set as an edition section, and encoding is performed in the bound GOP section unit.

### ADVANTAGEOUS EFFECTS

According to the present invention, the time that it takes to encode a large amount of multimedia data after the multimedia data has been edited can be significantly reduced.

### BRIEF DESCRIPTION OF DRAWINGS

Further objects and advantages of the invention can be more fully understood from the following detailed description taken in conjunction with the accompanying drawings in which:

FIG. 1 is a construction schematically showing an internal construction of a motion picture encoding apparatus according to an embodiment of the present invention;

FIG. 2 is a flowchart showing a motion picture encoding method according to an embodiment of the present invention; and

FIG. 3 is a diagram showing target motion picture data to be edited, edited motion picture data and encoded motion picture data according to an embodiment of the present invention.

### MODE FOR THE INVENTION

Detailed content about the object, technical constructions, and operational effects thereof according to the present invention will be clearly understood from the following detailed description of the present invention, which is taken in conjunction with the accompanying drawings. Embodiments of the present invention will now be described in detail with reference to the accompanying drawings.

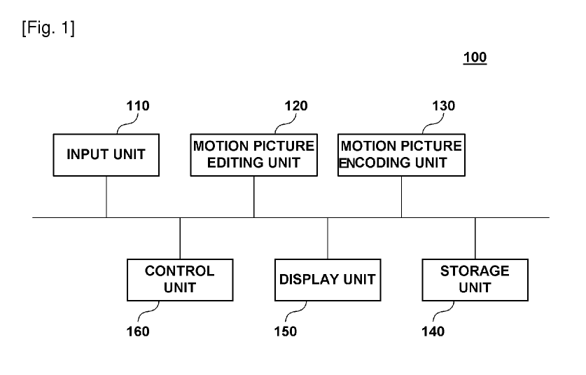

FIG. 1 is a construction schematically showing an internal construction of a motion picture encoding apparatus according to an embodiment of the present invention.

Referring to FIG. 1, a motion picture encoding apparatus 100 according to the present invention includes an input unit 110, a motion picture editing unit 120, a motion picture encoding unit 130, a storage unit 140, a display unit 150 and a control unit 160.

Here, the motion picture encoding apparatus 100 can be applied to terminal devices, such as a personal computer (PC), a mobile communication terminal and a PDA, which is capable of playing multimedia data irrespective of wired communication or wireless communication.

The input unit 110 is equipped with a plurality of buttons, such as characters, numerals and symbols, for inputting commands regarding an operation of the apparatus, and is configured to receive an editing command regarding motion picture data from a user.

The motion picture editing unit 120 is configured to edit motion picture data according to an editing command. At this time, types of editions performed in the motion picture editing unit 120 include deleting unnecessary frames from motion picture data, adding new frames to motion picture data, applying an image processing effect to motion picture data, and so on.

The motion picture encoding unit 130 is configured to encode motion picture data edited in the motion picture editing unit 120. Further, the motion picture encoding unit 130 encodes motion picture data that is not being edited.

Here, the motion picture editing unit 120 and the motion picture encoding unit 130 operate at the same time in parallel.

The storage unit 140 is configured to store encoded motion picture data. Target motion pictures to be edited are classified according to criteria, such as a title, a playback time and a capacity, and stored in other storage areas of the storage unit 140.

The display unit 150 is configured to display motion picture data that is being played and also display an operating state of the apparatus.

The control unit 160 controls the motion picture encoding unit 130 so that the motion picture encoding unit 130 encodes motion picture data that has been edited or motion picture data that is not being edited, while controlling the motion picture editing unit 120 to edit motion picture data.

Further, the control unit 160 determines whether motion picture data is an encoded motion picture and, if, as a result of the determination, the motion picture data is determined not to be an encoded motion picture, controls the first frame to last frame of the motion picture so that the frames are encoded.

Further, in relation to motion picture data to be encoded, the control unit 160 controls the motion picture encoding unit 130 so that the motion picture encoding unit 130 encodes the data of sections other than a picture section of a portion, which is being edited by the motion picture editing unit 120.

Further, when the motion picture editing unit 120 edits other picture sections of motion picture data after editing a specific picture section, the control unit 160 controls the motion picture encoding unit 130 so that the motion picture encoding unit 130 encodes the data of the specific picture section that has already been edited.

Further, in the case in which edition is not performed in an edition section of motion picture data that is being edited by the motion picture editing unit 120, the control unit 160 controls the motion picture encoding unit 130 so that the motion picture encoding unit 130 encodes the edition section on which edition has not been performed.

Further, in the case in which a picture section encoded by the motion picture encoding unit 130 is edited by the motion picture editing unit 120, the control unit 160 controls the motion picture encoding unit 130 so that the motion picture encoding unit 130 encodes the edited picture section again.

Meanwhile, in the case in which motion picture data is Moving Picture Expert Group (MPEG)-based motion picture data, the motion picture encoding unit 130 performs encoding on the MPEG-based motion picture data in a Group Of Picture (GOP) unit.

At this time, when the picture section edited by the motion picture editing unit 120 differs from the GOP unit, the motion picture editing unit 120 binds one or more GOPs and sets them as an edition section, and the motion picture encoding unit 130 encodes the bound GOP section unit.

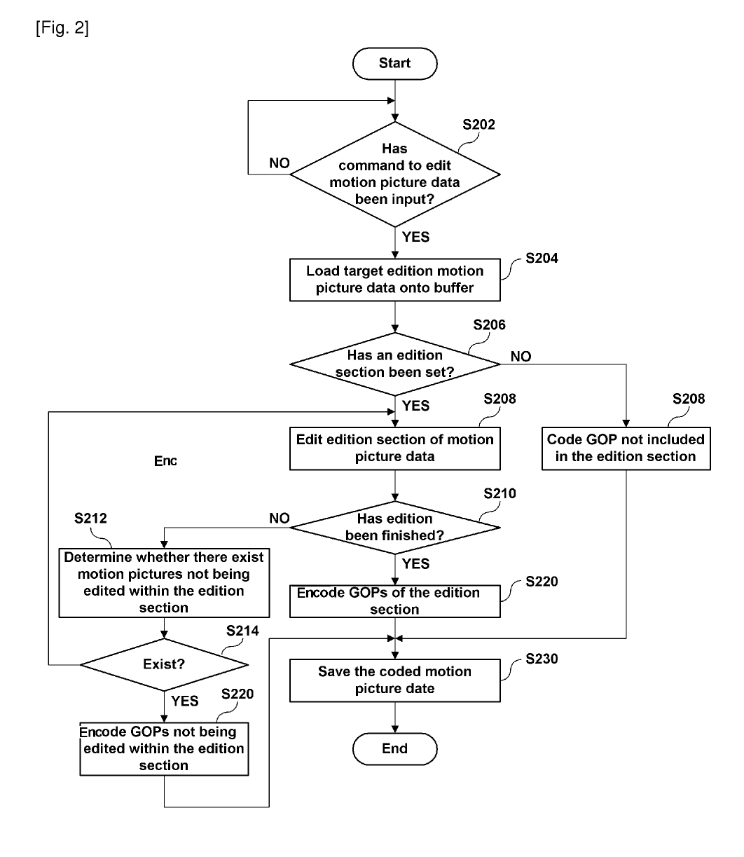

FIG. 2 is a flowchart showing a motion picture encoding method according to an embodiment of the present invention.

Referring to FIG. 2, a user inputs a command for editing motion picture data through the input unit 110 (S202). The user selects motion picture data, which will be edited, using a motion picture edition menu.

The control unit 160 fetches the target edition motion picture data, which has been selected by the user, from the storage unit 140 and loads the fetched motion picture data onto a buffer (S204).

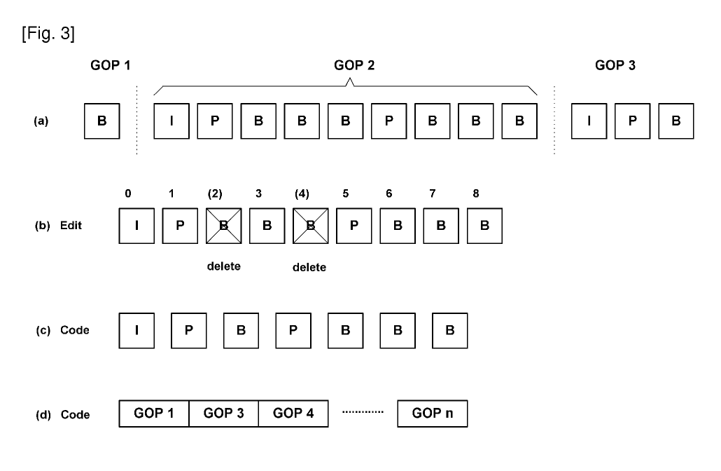

Next, the control unit 160 displays the loaded motion picture data on the display unit 150 as shown in (a) of FIG. 3. Here, FIG. 3 is a diagram showing target motion picture data to be edited, edited motion picture data and encoded motion picture data according to an embodiment of the present invention

The motion picture data shown in (a) of FIG. 3 is, for example, MPEG-based motion picture and includes I pictures, P pictures, and B pictures comprised in a GOP unit. In the case of the I picture, it can be played by itself without referring to other pictures and requires the largest bits. The P picture comprises portions being a difference as a result of referring to I pictures or other P pictures in one way and requires less bits than that of the I picture. The B picture comprises portions being a difference as a result of referring to I pictures or P pictures in one way and requires the smallest bits.

The user designates an edition section corresponding to, for example, a second GOP as shown in (b) of FIG. 3 by manipulating the input unit 110, and the control unit 160 displays motion picture data of the second GOP, corresponding to the edition section, on the display unit 150 (S206).

The user then inputs an editing command to delete some pictures with respect to the edition section of the motion picture data, as shown in (b) of FIG. 3. In response thereto, the motion picture editing unit 120 performs edition for deleting a second B picture and a fourth B picture of the second GOP corresponding to the edition section shown in (b) of FIG. 3 (S208).

While controlling the motion picture editing unit 120 to perform the above-described motion picture edition, the control unit 160 controls the motion picture encoding unit 130 so that the motion picture encoding unit 130 encodes motion picture data (i.e., a first GOP, a third GOP, and a nth GOP other than the second GOP being the target edition motion picture as shown in (d) of FIG. 3) on which the edition is not being performed because the motion picture data is not included in the edition section (S206-NO) (S208).

At this time, the motion picture encoding unit 130 performs encoding on the first

GOP, the third GOP and the nth GOP, which are not included in the edition section, from a first frame to a last frame of the motion picture.

While the motion picture editing unit 120 performs edition on the second GOP edition section of the motion picture data (S210-NO), the control unit 160 determines whether motion pictures that are not being edited exist within the edition section (S212). That is, the control unit 160 determines whether there exist motion pictures that are not being edited, such as I pictures or P pictures of the second GOP corresponding to the edition section, as shown in (b) of FIG. 3. If there exist motion pictures that are not being edited, such as I pictures or P pictures, within the edition section (S214), the control unit 160 controls the motion picture encoding unit 130 so that the motion picture encoding unit 130 encodes the motion pictures that are not being edited within the edition section (S220).

If there do not exit motion pictures that are not being edited within the edition section of the motion picture data (S214-NO), the operation of editing the second GOP (S208) is repeated.

Meanwhile, in the case in which the edition on the second GOP edition section of the motion picture data is finished by the motion picture editing unit 120 (S210-YES), the control unit 160 controls the motion picture encoding unit 130 so that the motion picture encoding unit 130 encodes the second GOP that has been edited, as shown in (c) of FIG. 3 (S220).

That is, the control unit 160 encodes GOPs, being not edited, within the edition section (S220) and, at the same time, encodes GOPs of the edition section in parallel (S220).

Further, in the case in which the first GOP, the second GOP and the third GOP are set to the edition section, the control unit 160 may encode the first GOP and the third GOP other than the second GOP that is currently being encoded (S220).

Further, when the motion picture editing unit 120 edits the remaining picture sections of motion picture data after editing a specific picture section, i.e., the second GOP of the motion picture data, the control unit 160 controls the motion picture encoding unit 130 so that the motion picture encoding unit 130 encodes the second GOP section that has already been edited.

Further, in the case in which the second GOP section encoded by the motion picture encoding unit 130 is edited again by the motion picture editing unit 120, the control unit 160 controls the motion picture encoding unit 130 so that the motion picture encoding unit 130 encodes the edited second GOP section again.

Next, in the case in which a picture section edited by the motion picture editing unit 120 differs from a GOP unit, the control unit 160 controls the motion picture editing unit 120 so that the motion picture editing unit 120 binds one or more GOPs and sets them as an edition section, and controls the motion picture encoding unit 130 so that the motion picture encoding unit 130 encodes the bound GOP section as a unit.

The motion picture data that has been encoded through the above-described process is stored in the storage unit 140 (S230).

Meanwhile, the motion picture encoding method according to the present invention may be recorded in a recording medium as a program for editing motion picture data using the motion picture editing unit 120 and encoding the edited motion picture data using the motion picture encoding unit 130. At this time, the program is a program for processing the steps of (a) receiving a command to edit motion picture data; (b), while editing motion picture data using the motion picture editing unit 120 according to the editing command, encoding motion picture data on which edition has been completed using the motion picture encoding unit 130; and (c) storing the encoded motion picture data.

Here, the step (b) includes determining whether the motion picture data is encoded motion picture data or not, and, if, as a result of the determination, the motion picture data is not encoded motion picture data, performing encoding on a first frame to a last frame of the motion picture using the motion picture encoding unit 130.

Further, the step (b) includes encoding data of sections other than the picture section of the portion, which is being edited by the motion picture editing unit 120, using the motion picture encoding unit 130.

Further, the step (b) includes, when the motion picture editing unit 120 edits other picture sections of the motion picture data after editing a specific picture section of the motion picture data, encoding data of the specific picture section on which the edition has been completed using the motion picture encoding unit 130.

Further, the step (b) includes, in the case in which the edition is not performed in the edition section of the motion picture data that is being edited by the motion picture editing unit 120, encoding the edition section in which the edition is not performed using the motion picture encoding unit 130.

Further, the step (b) includes, in the case in which the picture section encoded by the motion picture encoding unit 130 is edited by the motion picture editing unit 120, encoding the edited picture section again using the motion picture encoding unit 130.

Further, the step (b) includes, when the motion picture data is MPEG-based motion picture data, encoding the motion picture data in a GOP unit.

Next, in the case in which the picture section edited in the motion picture editing unit 120 differs from a GOP unit, the motion picture editing unit 120 binds one or more GOPs and sets them as an edition section. The motion picture encoding unit 130 encodes the bound GOP section as a unit.

As described above, according to the motion picture encoding apparatus and method in accordance with the present invention, in a process of editing pictures, such as deleting some frames in a motion picture, adding new frames to a motion picture, applying some image processing effects to a motion picture, or storing edited motion pictures, a part of a motion picture which has already been edited is encoded simultaneously with the edition of the other part of the motion picture which has not yet been edited. According to the invention, it is possible to reduce the time to code a motion picture significantly.

Those skilled in the art can implement the present invention in various forms without departing from the technical spirit or indispensable characteristics of the present invention. Therefore, the above-described embodiments are only illustrative from all aspects, and should not be construed to limit the scope of the present invention.

### INDUSTRIAL APPLICABILITY

The present invention can be applied to a PDA and terminals for communication, such as mobile communication terminals, which receive multimedia data in streaming form and display the multimedia data.

Further, the present invention can be applied to terminal apparatus, such as personal computers, PMPs, and notebook computers, in which a user deletes unnecessary frames from downloaded multimedia data or adds desired frames to downloaded multimedia data, and then encodes and stores the downloaded multimedia data.

Next, the present invention can be applied to a digital motion picture editor or an image edition system of a broadcasting company, for performing an image process on video stored in digital form.

1. A motion picture encoding apparatus, comprising:
an input unit inputting a command to edit motion picture data;
a motion picture editing unit editing the motion picture data according to the editing command;
a motion picture encoding unit encoding the edited motion picture data;
a storage unit for storing the encoded motion picture data; and
a control unit which controls the motion picture editing unit so that the motion picture editing unit edits motion picture data and, at the same time, controls the motion picture encoding unit so that the motion picture encoding unit encodes edited data.

2. The motion picture encoding apparatus of claim 1, wherein the motion picture editing unit and the motion picture encoding unit operate at the same time in parallel.

3. The motion picture encoding apparatus of claim 1, wherein the control unit determines whether the motion picture data is encoded motion picture or not and, if the motion picture data is not encoded motion picture, performs encoding on a first frame to a last frame of the motion picture.

4. The motion picture encoding apparatus of claim 1, wherein, in relation to motion picture data to be encoded, the control unit controls the motion picture encoding unit so that the motion picture encoding unit encodes data of sections other than a picture section of a portion, which is being edited by the motion picture editing unit.

5. The motion picture encoding apparatus of claim 1, wherein, when the motion picture editing unit edits other picture sections of motion picture data after editing a specific picture section of the motion picture data, the control unit controls the edited picture section so that the edited picture section is encoded.

6. The motion picture encoding apparatus of claim 1, wherein, in the case in which edition is not performed in a current edition section of motion picture data that is being edited by the motion picture editing unit, the control unit controls the edition section so that the edition section is encoded.

7. The motion picture encoding apparatus of claim 1, wherein, in the case in which a picture section encoded by the motion picture encoding unit is edited by the motion picture editing unit, the control unit controls the edited picture section so that the edited picture section is encoded again.

8. The motion picture encoding apparatus of claim 1, wherein, in the case in which the motion picture data is Moving Picture Expert Group (MPEG)-based motion picture data, the motion picture encoding unit performs encoding on the motion picture data in a Group Of Picture (GOP) unit.

9. The motion picture encoding apparatus of claim 8, wherein, when a picture section edited by the motion picture editing unit differs from a GOP unit, the motion picture editing unit binds one or more GOPs and sets the bound GOPs as an edition section, and the motion picture encoding unit performs encoding in the bound GOP section unit.

10. A motion picture encoding method, comprising the steps of:
(a) receiving a command to edit motion picture data;
(b) while editing the motion picture data using a motion picture editing unit according to the editing command, encoding motion picture data on which edition has been completed using a motion picture encoding unit; and
(c) storing the encoded motion picture data.

11. The motion picture encoding method of claim 10, wherein the step (b) includes determining whether the motion picture data is encoded motion picture data or not, and, if the motion picture data is not encoded motion picture data, performing encoding on a first frame to a last frame of the motion picture.

12. The motion picture encoding method of claim 10, wherein the step (b) includes encoding data of sections other than the picture section of the portion, which is being edited.

13. The motion picture encoding method of claim 10, wherein the step (b) includes, when editing other picture sections of the motion picture data after editing a specific picture section of the motion picture data, encoding data of the specific picture section on which the edition has been completed.

14. The motion picture encoding method of claim 10, wherein the step (b) includes, in the case in which edition is not performed in a current edition section of the motion picture data that is being edited, encoding the edition section in which the edition is not performed.

15. The motion picture encoding method of claim 10, wherein the step (b) includes, in the case in which encoded picture section is edited, encoding the edited picture section again.

16. The motion picture encoding method of claim 10, wherein the step (b) includes, when the motion picture data is MPEG-based motion picture data, encoding the motion picture data in a GOP unit.

17. The motion picture encoding method of claim 16, wherein, in the case in which the edited picture section differs from a GOP unit, one or more GOPs are bound, the bound GOPs is set as an edition section, and encoding is performed in the bound GOP section unit.

18. A recording medium in which a program for executing a method according to claim 10 is recorded.

19. A recording medium in which a program for executing a method according to claim 11 is recorded.

20. A recording medium in which a program for executing a method according to claim 12 is recorded.

21. A recording medium in which a program for executing a method according to claim 13 is recorded.

22. A recording medium in which a program for executing a method according to claim 14 is recorded.

23. A recording medium in which a program for executing a method according to claim 15 is recorded.

24. A recording medium in which a program for executing a method according to claim 16 is recorded.

25. A recording medium in which a program for executing a method according to claim 17 is recorded.
